(19) United States
(12) Patent Application Publication
(10) Pub. No.: US 2021/0197643 A1
(43) Pub. Date: Jul. 1, 2021

(54) TEMPERATURE CONTROL SYSTEM AND TEMPERATURE CONTROL METHOD

(71) Applicant: Industrial Technology Research Institute, Hsinchu (TW)

(72) Inventors: Jui-Wen Yang, New Taipei City (TW); Yi-Cheng Lu, Hsinchu City (TW); Min-Hsiung Liang, Taichung City (TW); Tzu-Hao Yu, Yilan County (TW); Tzu-Yang Ting, Taipei City (TW)

(73) Assignee: Industrial Technology Research Institute, Hsinchu (TW)

(21) Appl. No.: 16/835,294

(22) Filed: Mar. 30, 2020

(30) Foreign Application Priority Data
Dec. 31, 2019 (TW) 108148645

(51) Int. Cl. B60H 1/00; B60H 1/03; B60H 1/22

(52) U.S. Cl. CPC B60H 1/00278; B60H 1/00007; B60H 1/00392; B60H 1/2225; B60H 1/00735; B60H 1/03; B60H 1/2218; B60H 1/00428

(57) ABSTRACT

A temperature control method, including periodically sensing an air temperature of a space, and periodically sensing a surface temperature of each of a plurality of interior surfaces; in response to the air temperature and the surface temperatures being less than a target temperature, calculating an air heating duration of an air conditioner and a surface heating duration of each of a plurality of heater devices arranged in an array according to the target temperature, the air temperature and the surface temperatures; performing an air heating operation according to the air heating duration and performing surface heating operations according to the surface heating durations; and in response to the air temperature currently sensed and the surface temperatures currently sensed reaching the target temperature, instructing the air conditioner to stop performing the air heating operation.

### CROSS-REFERENCE TO RELATED APPLICATION

This application claims the priority benefit of Taiwan application no. 108148645, filed on Dec. 31, 2019. The entirety of the above-mentioned patent application is hereby incorporated by reference herein.

### TECHNICAL FIELD

The disclosure relates to a temperature control system and relates to a temperature control system and a temperature control method adapted to a space.

### BACKGROUND

With the development of technology, vehicles that use an electric motor as a driving power source (e.g., electric vehicles or hybrid electric vehicles) are also becoming more and more popular.

In general, with respect to a battery of the vehicle, other than providing power to the electric motor, the battery also needs to provide power to various other electronic devices of the vehicle for these electronic devices to operate.

In particular, under the circumstance that a battery capacity is fixed, when the weather is cold, the battery may need to provide a large amount of power to an in-vehicle heating system in order to keep the driver/passenger comfort in the vehicle. Accordingly, as there will be a large amount of consumption on power stored in the battery because of the in-vehicle heating system, a total operating time/endurance of the vehicle may be reduced. In addition, some conventional in-vehicle heating systems may continue to heat up seats in the vehicle, resulting in discomfort to the driver/passenger.

Therefore, how to reduce the energy consumption of the heating system in the vehicle to increase a power utilization efficiency of the battery and enhance the total operating time/endurance of the vehicle is the goal to be achieved by persons skilled in the art.

### SUMMARY

An embodiment of the disclosure provides a temperature control system adapted to a space. The system includes an air conditioner, a surface heating system, a temperature detection system and a processor. The surface heating system includes a plurality of heater devices arranged in an array and respectively disposed on a plurality of interior surfaces of the space, and the plurality of heater devices are configured to heat up the plurality of interior surfaces. The temperature detection system includes a first temperature sensing device and a plurality of second temperature sensing devices, wherein the first temperature sensing device is configured to periodically sense an air temperature of the space, wherein the plurality of second temperature sensing devices are respectively disposed on the plurality of interior surfaces of the space, and configured to periodically sense a surface temperature of each of the plurality of interior surfaces. In response to the air temperature and the surface temperatures being less than a target temperature, the processor is configured to perform a first stage of a temperature control procedure. In the first stage, the processor is further configured to calculate an air heating duration of the air conditioner and a surface heating duration of each of the plurality of heater devices according to the target temperature, the air temperature and the plurality of surface temperatures. In addition, the processor is further configured to instruct the air conditioner to perform an air heating operation according to the air heating duration, and instruct each of the plurality of heater devices to perform a surface heating operation according to the corresponding surface heating duration. In addition, in response to the air temperature currently sensed and the plurality of surface temperatures currently sensed reaching the target temperature, the processor is further configured to instruct the air conditioner to stop performing the air heating operation so as to finish performing the first stage.

An embodiment of the disclosure provides a temperature control method adapted to a temperature control system of a space, wherein the temperature control system includes an air conditioner, a surface heating system, a temperature detection system and a processor, wherein the surface heating system includes a plurality of heater devices arranged in an array and respectively disposed on a plurality of interior surfaces of the space. The method includes periodically sensing an air temperature of the space by a first temperature sensing device of the temperature detection system, and periodically sensing a surface temperature of each of the plurality of interior surfaces by a plurality of second temperature sensing devices of the temperature detection system, wherein the plurality of second temperature sensing devices are respectively disposed on the plurality of interior surfaces of the space; in response to the air temperature and the surface temperatures being less than a target temperature, performing a first stage of a temperature control procedure. In the first stage, an air heating duration of the air conditioner and a surface heating duration of each of the plurality of heater devices are calculated according to the target temperature, the air temperature and the plurality of surface temperatures; an air heating operation is performed by the air conditioner according to the air heating duration, and a surface heating operation is performed by each of the plurality of heater devices according to the corresponding surface heating duration; and in response to the air temperature currently sensed and the surface temperatures currently sensed reaching the target temperature, the air conditioner is instructed to stop performing the air heating operation, so as to finish performing the first stage.

An embodiment of the disclosure provides a temperature control system adapted to a space. The system includes an air conditioner, a surface heating system, a temperature detection system and a processor. The surface heating system includes a plurality of heater devices arranged in an array and respectively disposed on a plurality of interior surfaces of the space, and the plurality of heater devices are configured to heat up the plurality of interior surfaces. The temperature detection system includes a first temperature sensing device and a plurality of second temperature sensing devices, wherein the first temperature sensing device is configured to periodically sense an air temperature of the space, wherein the plurality of second temperature sensing devices are respectively disposed on the plurality of interior surfaces of the space, and configured to periodically sense a surface temperature of each of the plurality of interior surfaces. The processor is configured to receive a space use time through a communication circuit unit of the space. In addition, in response to the air temperature and the surface temperatures being less than a target temperature, the processor is further configured to perform a first stage of a temperature control procedure according to the space use time. In the first stage, the processor is further configured to calculate an air heating duration of the air conditioner and a surface heating duration of each of the plurality of heater devices according to the target temperature, the air temperature and the plurality of surface temperatures. In addition, the processor is further configured to calculate an air heating start time corresponding to the air conditioner according to the air heating duration and the space use time, and calculate a plurality of surface heating start times corresponding to the plurality of heater devices according to the plurality of surface heating durations and the space use time, wherein before the space use time, the processor is further configured to instruct the air conditioner to perform an air heating operation at the air heating start time, and each of the plurality of heater devices is instructed to perform a surface heating operation at the plurality of surface heating start times such that the air temperature and the plurality of surface temperatures are able to reach the target temperature at the space use time.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a temperature control system illustrated according to an exemplary embodiment of the disclosure.

FIG. 2A is a schematic diagram of a space and a temperature control system illustrated according to an embodiment of the disclosure.

FIG. 2B is a block diagram of a surface heater device group in a surface heating system illustrated according to an embodiment of the disclosure.

FIG. 2C is a schematic diagram of temperature adjustment units/array units disposed in an array illustrated according to an embodiment of the disclosure.

FIG. 3A is a flowchart of a temperature control method illustrated according to an embodiment of the disclosure.

FIG. 3B is a flowchart of a temperature control method illustrated according to another embodiment of the disclosure.

FIG. 3C is a flowchart of a second stage and a third stage in a temperature control procedure in a temperature control method illustrated according to an embodiment of the disclosure.

FIG. 3D is a flowchart of a second stage and a third stage in a temperature control procedure in a temperature control method illustrated according to another embodiment of the disclosure.

FIG. 4A is a schematic diagram of a temperature distribution map of second temperature sensing devices on interior surfaces at different time points illustrated according to an embodiment of the disclosure.

FIG. 4B is a schematic diagram of a plurality of first target heaters/first target temperature adjustment units and a plurality of second target heaters/second target temperature adjustment units determined based on a temperature distribution map of second temperature sensing devices illustrated according to an embodiment of the disclosure.

FIG. 5 is a schematic diagram of multiple stages in a temperature control system illustrated according to an exemplary embodiment of the disclosure.

FIG. 6 is a schematic diagram of temperature adjustment units disposed in different areas illustrated according to an embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

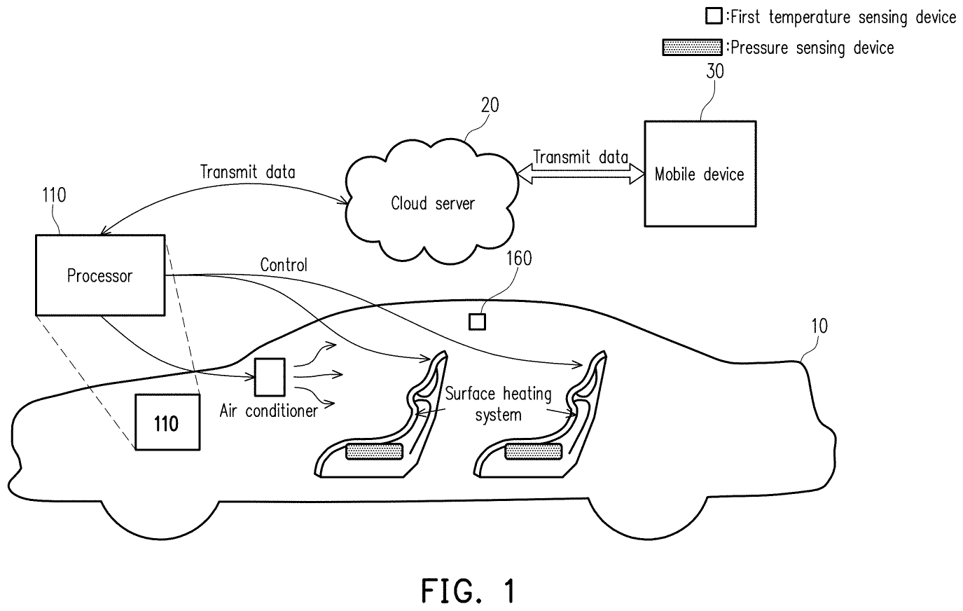

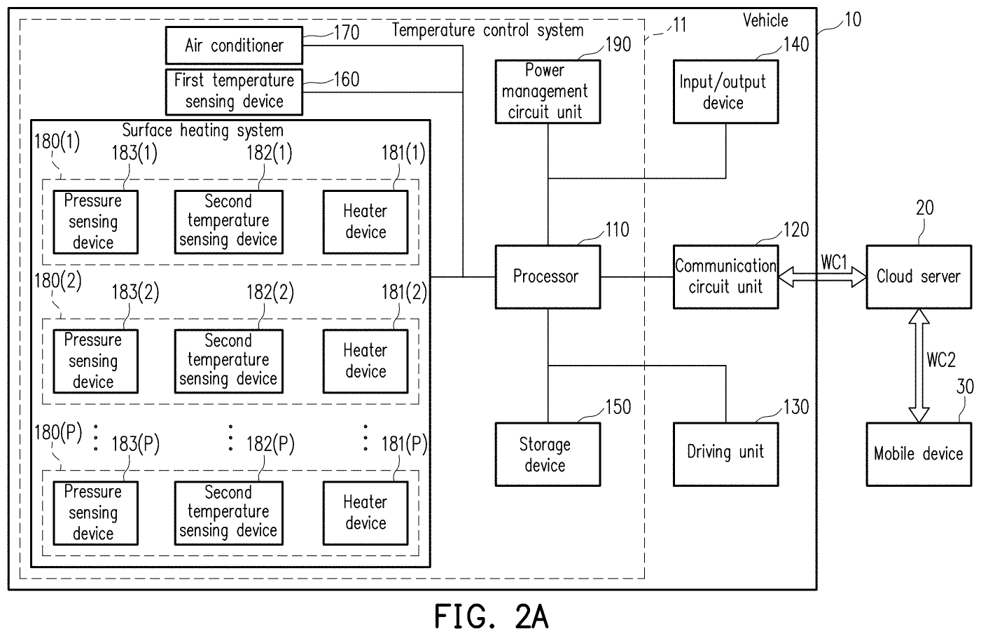

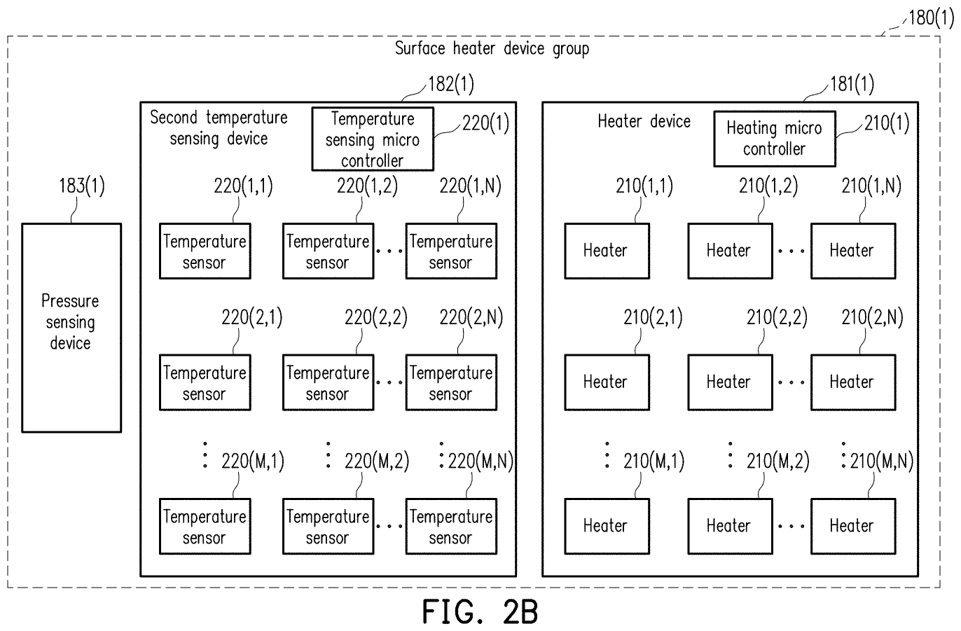

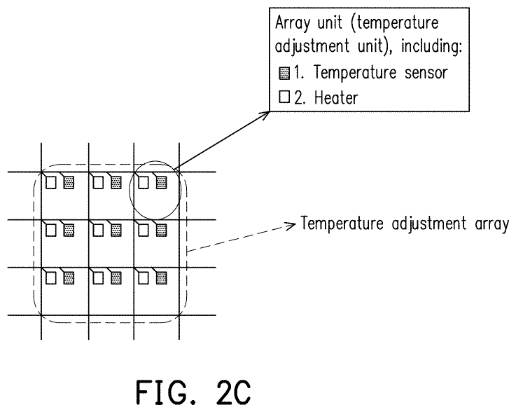

FIG. 1 is a schematic diagram of a temperature control system illustrated according to an exemplary embodiment of the disclosure. Referring to FIG. 1, in this embodiment, in order to effectively heat up a vehicle 10 (e.g., a space), a processor 110 of the vehicle 10 controls durations of heating operations of an air conditioner 170 and a surface heating system 180 according to an air temperature sensed by a first temperature sensing device 160 (or cooperate with surface temperatures sensed by the surface heating system 180) and a target temperature. The target temperature is set in advance (e.g., one temperature value between 20 and 28 degrees Celsius, or other preset temperature value). In another embodiment, the processor 110 may receive data from a cloud server 20, so as to calculate start time points of the heating operations of the air conditioner 170 and the surface heating system 180. The data is, for example, information regarding a vehicle use time (e.g., a space use time) or a vehicle use schedule (e.g., a space use schedule) sent by a mobile device 30 of a driver (e.g., a main manager or a user of the space). In other words, with the vehicle use time or the vehicle use schedule set by the driver, the vehicle 10 may smartly heat up the vehicle 10 at the calculated start time points and have the vehicle 10 heated up to the target temperature before a to-be-used time (corresponding to the vehicle use time or the vehicle use schedule) so that the driver may feel a comfortable temperature when entering the vehicle 10 and starting to use the vehicle 10 (since the air temperature and the surface temperatures of interior surfaces that the driver is in contact with have been heated up to the target temperature within a general comfort range). The hardware architecture of the vehicle 10 and the temperature control system is further described below with reference to FIG. 2A.

It should be reminded that, for ease of understanding, most of the embodiments of the disclosure use vehicles (e.g., the vehicle 10) as an example, but the application level of the disclosure is not limited to vehicles. The temperature control method and the temperature control system provided in the embodiments of the disclosure may also be applied to other types of vehicles other than automobiles, or to other rooms (or spaces) that need to adjust an indoor temperature and surface temperatures of indoor objects. The surface of the indoor object may also be referred to as the interior surface. For example, if the temperature control method and the temperature control system provided in the embodiments of the disclosure are applied to a non-vehicle space (e.g., a playground, a stadium, a factory, a conference room, an office, a store, or various rooms in the home, or other forms of hermetic spaces in which temperature may be controlled), the driver/passenger corresponding to the vehicle may also be replaced by a primary or secondary user (or creatures) who will use the space, and the space use time, the space use schedule and the target temperature also may also be preset in accordance with the user. In the following, the vehicle 10 is taken as an example of the space, and the temperature control method and the temperature control system provided by the disclosure will be described through multiple embodiments and drawings.

FIG. 2A is a schematic diagram of a space and a temperature control system illustrated according to an embodiment of the disclosure. Referring to FIG. 2A, a temperature control system 11 of the vehicle 10 (a.k.a. the space 10) includes the processor 110, a storage device 150, the first temperature sensing device 160, the air conditioner 170, the surface heating system 180 and a power management circuit unit 190. The processor 110 is coupled (or electrically connected) to the storage device 150, the first temperature sensing device 160, the air conditioner 170, the surface heating system 180 and the power management circuit unit 190. In addition, the processor 110 is further coupled to a communication circuit unit 120, a driving unit 130 and an input/output device 140 of the vehicle. It should be noted that, when the space 10 applying the temperature control method and the temperature control system of the disclosure is non-vehicle, the space 10 does not have the driving unit 130.

The processor 110 is hardware (e.g., a chipset, a processor and the like) with computing capabilities, and is used to manage an overall operation of the vehicle 10 (e.g., control operations of other hardware components in the vehicle 10). In this embodiment, the processor 110 is, for example, a central processing unit (CPU) of single-core or multi-core, a micro-processor, other programmable processing unit, a digital signal processor (DSP), a programmable controller, an application specific integrated circuits (ASIC), a programmable logic device (PLD) or other similar devices.

The communication circuit unit 120 is configured to receive a communication signal through a wireless method. In this embodiment, the communication circuit unit 120 is a wireless communication circuit unit in compliance with, for example, WiFi protocol, Bluetooth, Near Field Communication (NFC), 3rd Generation Partnership Project (3GPP) standard, 4th Generation Partnership Project (4GPP) standard, 5th Generation Partnership Project (5GPP) standard and the like. In this embodiment, through one or more wireless network connections established, the communication circuit unit 120 may connect to the cloud server 20 (e.g., through a wireless network connection WC1) or the mobile device 30 (e.g., through the wireless network connection WC1 and a wireless network connection WC2). The data (e.g., the data is, for example, information regarding the vehicle use time or the vehicle use schedule sent from the mobile device 30 of the driver (the user of the vehicle)) may be transmitted between the vehicle 10, the cloud server 20 and the mobile device 30 through the established wireless network connections WC1 and WC2. In an embodiment, the communication circuit unit 120 is further configured to connect a network (e.g., a telecommunication network, the Internet, the Internet of Things or the like) so that the vehicle 10 may download or upload data from/to the connected network.

The driving unit 130 is configured to control the movement of the vehicle 10 according to an instruction of the processor 110. The driving unit 130 may control a movement direction, a speed, and an acceleration of the vehicle 10 by controlling the mechanical system and the power system of the vehicle 10. In an embodiment, the driving unit 130 may return data regarding a temperature of an engine in the driving unit 130 to the processor 110. Then, the processor 110 may instruct the temperature control system 11 to use a heat conduction method to receive the thermal energy emitted by the engine in the driving unit 130 to heat up the interior surface to be heated, or use thermal convection to receive thermal energy emitted by the engine in the driving unit 130 to assist an air heating operation of the air conditioner. This disclosure is not limited to the implementation of the driving unit 130, and details about the driving unit 130 are not described in detail here.

The input/output unit 140 is, for example, a touch panel, which is used to allow the user to input data or control an operation desired by the user via the input/output unit 140. In addition, the input/output unit 140 can also display/play information. In this embodiment, the user/passenger may also perform an input operation/input instruction on the input/output unit 140 to set one or more parameters related to the temperature control procedure performed by the temperature control system 11 or adjust the air heating operation or a surface heating operation currently performed. The parameter is, for example, the target temperature or one or more parameters for setting the vehicle use schedule.

The storage device 150 temporarily stores data according to the instruction of the processor 110. The data includes system data for managing the vehicle, an obtained temperature sensing value, an obtained pressure sensing value and the like, but the disclosure is not limited thereto. In addition, the storage device 150 may also record data that need to be stored for a long time based on the instruction of the processor 110 (e.g., one or more parameters regarding the temperature control procedure performed by the temperature control system 11, a historical temperature sensing value, a historical pressure sensing value, a historical temperature distribution map, firmware or software for managing the vehicle 10). The storage device 150 may be any type of hard disk drive (HDD) or non-volatile memory storage device (e.g., a solid state drive). In an embodiment, the storage device 150 may also be a hardware that contains a flash memory module.

The power management circuit 190 is configured to manage power to be provided to each hardware element of the vehicle 10. The power management circuit unit 190 may include a battery.

The first temperature sensing device 160 is configured to periodically sense an air temperature of the space in the vehicle 10. A value of the air temperature is then transmitted to the processor 110.

According to the instruction of the processor 110, the air conditioner 170 is configured to perform a corresponding air conditioning operation (e.g., the air heating operation), so as to blow air with a corresponding temperature value through one or more air outlets, thereby controlling the air temperature of the space in the vehicle 10 to be the target temperature. The air conditioner 170 may include a heat pump.

In this embodiment, the surface heating system 180 includes a plurality of surface heater device groups 180(1) to 180(P) respectively disposed a plurality of interior surfaces in the vehicle. The surface heater device groups 180(1) to 180(P) include heater devices 181(1) to 181(P) arranged in an array, second temperature arrays 182(1) to 182(P) and pressure sensing devices 183(1) to 183(P), wherein P is a positive integer. In the following, the hardware structure of the surface heater device group is described using FIG. 2B. The second temperature sensing arrays 182(1) to 182(P) and the first temperature sensing device 160 can be combined into a temperature detection system.

FIG. 2B is a block diagram of a surface heater device group in a surface heating system illustrated according to an embodiment of the disclosure. Referring to FIG. 2B, with the surface heater device group 180(1) taken as an example, the surface heater device group 180(1) includes the heater device 181(1), the second temperature sensing device 182(1) and the pressure sensing device 183(3). The heater device 181(1) is configured to heat up the interior surface of the heater device group 180(1). The second temperature sensing device 182(1) is configured to periodically sense a surface temperature of the interior surface disposed with the surface heater device group 180(1). The pressure sensing device 183(1) is configured to periodically sense a pressure value (pressure/weight) to which the interior surface disposed with the surface heater device group 180(1) is subjected. For example, if the interior surface disposed with the surface heater device group 180(1) is a surface of a seat, the pressure sensing device 183(1) may sense the weight of the passenger sitting on the seat. As another example, if the interior surface disposed with the surface heater device group 180(1) is a surface of a steering wheel, the pressure sensing device 183(1) may sense a grip force applied to the steering wheel by the driver. The sensed pressure value is transmitted to the processor 110 for the processor 110 to determine whether the corresponding interior surface is touched by the passenger and then determine whether to perform a corresponding temperature control on the corresponding interior surface so that the passenger may feel more comfortable. In an embodiment, the processor 110 may identify the interior surface touched by the passenger, and instruct the air conditioner 170 to enable the air outlet corresponding to the interior surface among a plurality of air outlets for blowing out air with a corresponding temperature so that the passenger may feel more comfortable.

The plurality of interior surfaces include surfaces of one or more of a plurality of objects in the space in the vehicle 10 as described below: a plurality of seats; a plurality of windows; one or more sunroofs; a plurality of ceilings; a plurality of door panels; a steering wheel; and a plurality of floors. In other embodiments where the space 10 is not the vehicle, the interior surface of the space 10 may include, but is not limited to, one or more of the following surfaces: a plurality of ceilings; a plurality of windows; a plurality of floors; a plurality of walls; a plurality of pillar surfaces; a plurality of tables; a plurality of chairs; a plurality of furniture; a plurality of indoor facilities. In addition, in some embodiments, a liquid carried by a specific indoor facility (e.g., a swimming pool, a bathtub) that can be touched by a user may also be heated through an interior surface of the specific indoor facility.

The heater device 181(1) includes a heating micro controller (a heating micro control unit) 210(1) and a plurality of heaters 210(1,1) to 210(M,N) arranged in an array (M×N matrix), wherein M and N are positive integers. The second temperature sensing device 182(1) includes a temperature sensing micro controller (temperature sensing micro control unit) 220(1) and a plurality of temperature sensors 220(1,1) to 220(M,N) arranged in another array (M×N matrix), wherein M and N are positive integers. Here, the second temperature sensing device 182(1) corresponds to the heater device 181(1), and the plurality of temperature sensors 220(1,1) to 220(M,N) correspond to the plurality of heaters 210(1,1) to 210(M,N) corresponding to the heater device 181(1).

FIG. 2C is a schematic diagram of temperature adjustment units/array units disposed in an array illustrated according to an embodiment of the disclosure. Referring to FIG. 2B and FIG. 2C together, in this embodiment, each temperature sensor and the corresponding heater may compose one temperature adjustment unit (a.k.a. a temperature adjustment device), and the temperature adjustment unit may be regarded as one array unit of the temperature adjustment array. In other words, one interior surface may be divided into a plurality of array surfaces/array unit areas according to the corresponding array. Further, the temperature adjustment units/the array units in said one interior surface are disposed in a plurality of array unit surfaces/array unit areas of said one interior surface according to the corresponding array.

The temperature sensing micro controller 220 is coupled to the plurality of temperature sensors 220(1,1) to 220(M,N) and may obtain a surface sub-temperature sensed by each of the plurality of temperature sensors 220(1,1) to 220(M,N) (i.e., the surface temperature of the corresponding array unit surface/the array unit area). The temperature sensing micro controller 220 may calculate an average value of the plurality of surface sub-temperatures sensed by the plurality of temperature sensors 220(1,1) to 220(M,N) to be used as the surface temperature of the corresponding interior surface. The obtained surface temperature may be transmitted to the processor 110 through the temperature sensing micro controller 220. In addition, the plurality of surface sub-temperatures sensed by the plurality of temperature sensors 220(1,1) to 220(M,N) may also be transmitted to the processor 110 through the temperature sensing micro controller 220.

The first temperature sensing device 160 has a temperature sensor. Each of the temperature sensor of the first temperature sensing device 160 and the plurality of temperature sensors 220(1,1) to 220(M,N) of the second temperature sensing device 182(1) is, for example, a thermocouple, a resistance temperature detector (RTD), a thermistor or other suitable electronic temperature sensors. In addition, the temperature sensor of the first temperature sensing device 160 may also be an infrared temperature sensor or another type of temperature sensor for measuring the air temperature.

Each of the plurality of heaters 210(1,1) to 210(M,N) includes a film heater, a ceramic heater or a coil heater. In this embodiment, types of the heaters provided on different interior surfaces may be the same or different, and the disclosure is not limited thereto.

According to the instruction of the processor 110 (a control signal/a control command received from the processor 110), the heating micro controller 210(1) may use a corresponding power to enable/trigger one or more of the heaters 210(1,1) to 210(M,N) (so that the heaters 210(1,1) to 210(M,N) perform the corresponding heating operations).

In this example, the array is identical to said another array, but the disclosure is not limited thereto. For example, in another embodiment, the array is different from said another array (e.g., the second temperature sensing device 182(1) includes a plurality of second temperature sensors 220(1,1) to 220(Y,Z) arranged in another array (Y×Z array), wherein Y and Z are positive integers different from M and N).

For descriptive convenience, in the following embodiments, the array for arranging the plurality of heaters is the same as said another array for arranging the corresponding temperature sensors.

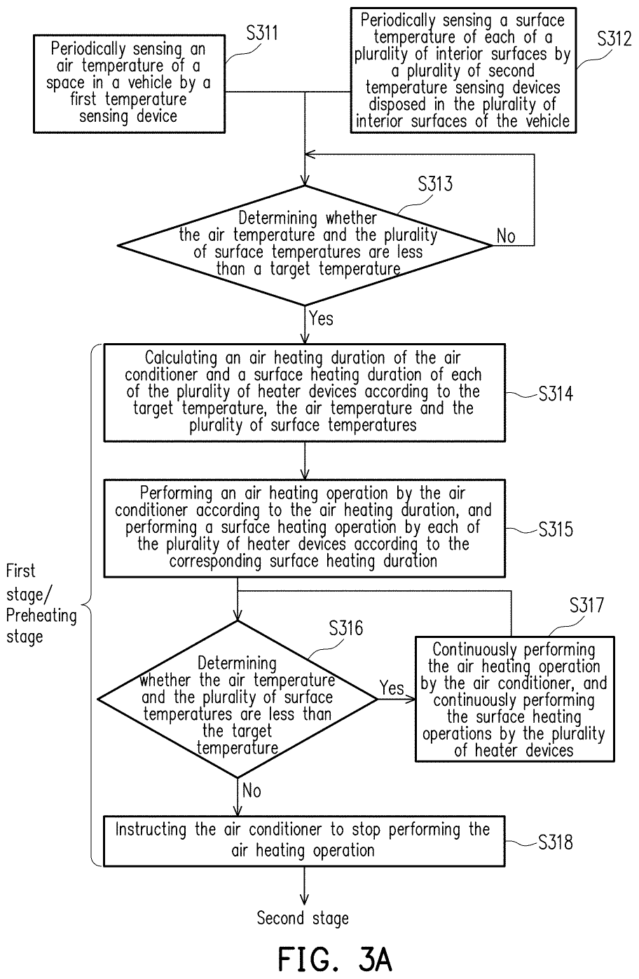

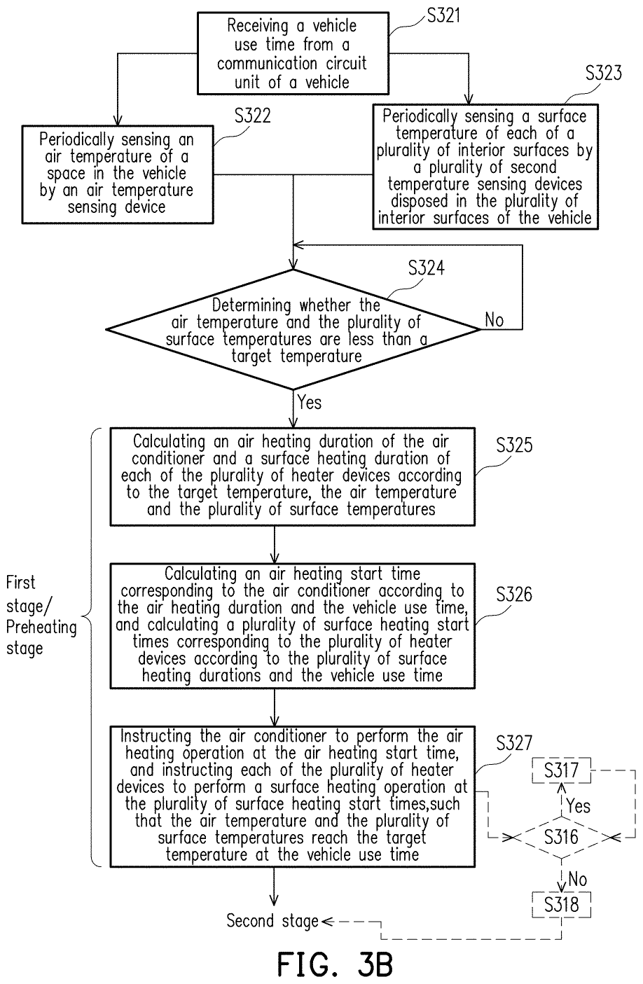

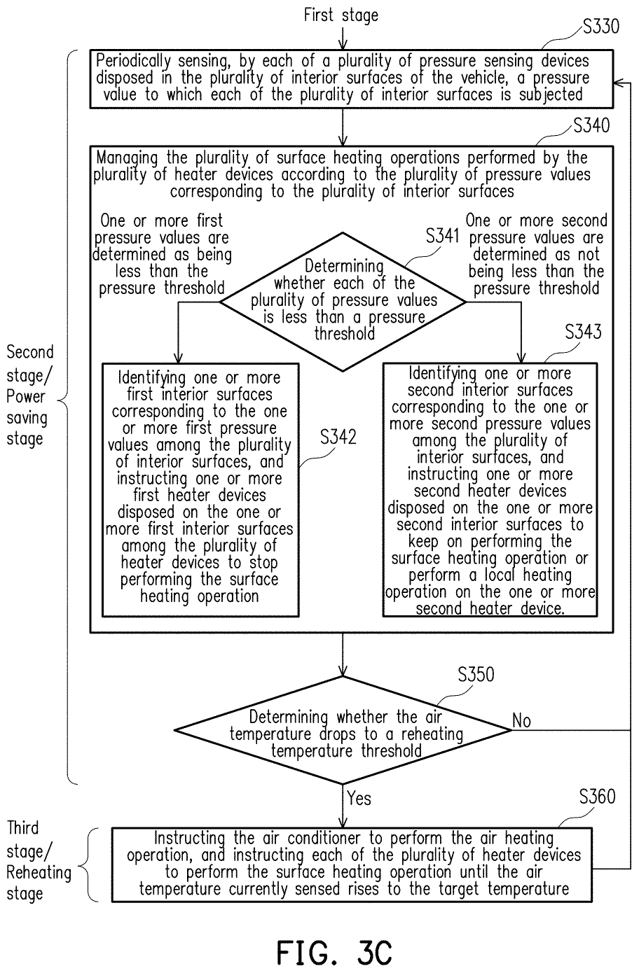

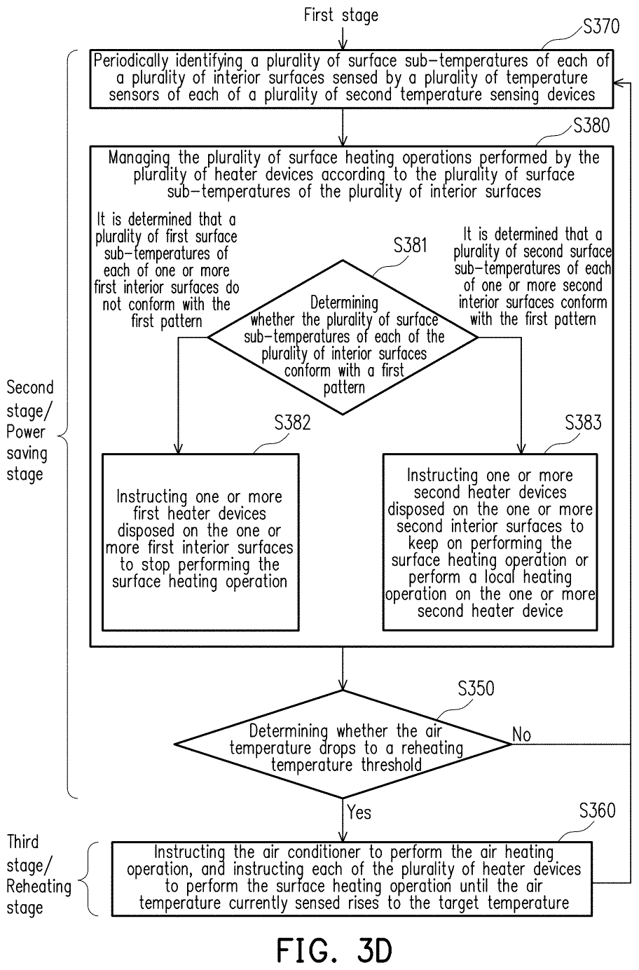

FIG. 3A is a flowchart of a temperature control method illustrated according to an embodiment of the disclosure. Referring to FIG. 3, in step S311, an air temperature of the space in the vehicle 10 (or the space 10) is periodically sensed by the first temperature sensing device 160. In addition, in step S312, a surface temperature of each of a plurality of interior surfaces is periodically sensed by a plurality of second temperature sensing devices 182(1) to 182(P) disposed in the plurality of interior surfaces (e.g., P interior surfaces) of the vehicle 10 (or the space 10). The processor 110 may periodically receive (a value of) the sensed air temperature from the first temperature sensing device 160, and periodically receive (values of) the surface temperatures of the plurality of sensed interior surfaces from the second temperature sensing devices 182(1) to 182(P) of the temperature detection system.

Next, in step S313, the processor 110 determines whether the air temperature and the surface temperatures is less than a target temperature. In this embodiment, the processor 110 may perform step S313 according to the preset vehicle use time, the vehicle use schedule and a received preheating instruction, so as to determine whether to perform a first stage (a.k.a. a preheating stage) to heat up the interior of the vehicle 10. The preheating instruction is, for example, sent to the vehicle 10 through the mobile device 30 and/or the cloud server 20 by the driver.

In response to the air temperature and the plurality of surface temperature being less than the target temperature, the processor 110 determines to perform the first stage (a.k.a. the preheating stage) in the temperature control procedure. Continuing to step S314, the processor 110 calculates an air heating duration of the air conditioner and a surface heating duration of each of a plurality of heater devices according to the target temperature, the air temperature and the plurality of surface temperatures.

If the air temperature and the plurality of surface temperatures are determined as not being less than the target temperature, whether the air temperature and the plurality of surface temperatures are less than the target temperature will be continuously determined.

The air heating duration may be calculated according to the following formula (1.1) and formula (1.2):

H_{Air}=mₐᵢᵣ×sₐᵢᵣ×(T′_{Air}−T_{Air}) (1.1)

t_{HP}=H_{Air}/(Q_{HP}×η_{HP}) (1.2)

H_{Air} is a total energy required for the air heating operation performed to rise to the target temperature in Joule (J); mₐᵢᵣ is a total mass of air in the space of the vehicle 10; sₐᵢᵣ is a specific heat of air in the space of the vehicle 10; Q_{HP} is the power of the air conditioner; η_{HP} is a thermoelectric efficiency of the air conditioner 170; T′_{Air} is the target temperature corresponding to the air temperature; T_{Air} is the sensed air temperature; t_{HP} is the air heating duration in seconds.

On the other hands, the surface heating duration may be calculated according to the following formula (2.1) and formula (2.2):

H_{Surface}=m_{Surface}×s_{Surface}×(T′_{Surface}−T_{Surface}) (2.1)

t_{SH}=H_{Surface}/(Q_{SH}×η_{SH}) (2.2)

H_{Surface} is a total energy required for the surface heating operations performed to rise to the target temperature in Joule (J); m_{Surface} is a total mass of the corresponding interior surface; s_{Surface} is a specific heat of the corresponding interior surface; Q_{SH} is the power of the corresponding surface heating array; η_{HP} is a thermoelectric efficiency of the corresponding surface heating array; T′_{Surface} is the target temperature corresponding to the surface temperature; T_{Surface} is the sensed surface temperature; t_{HP} is the surface heating duration in seconds.

Each of the parameters above, such as mₐᵢᵣ, sₐᵢᵣ, Q_{HP}, η_{HP}, m_{Surface}, s_{Surface}, Q_{SH}, η_{HP}, T′_{Air} and T′_{Surface} are all set in advance. In this embodiment, the target temperature corresponding to the air temperature (e.g., T′_{Air} is 23° C.) and the target temperature corresponding to the surface temperature (e.g., T′_{Surface} is 23° C.) are set with the same temperature value, but the disclosure is not limited thereto. For example, in another embodiment, the target temperature corresponding to the air temperature (e.g., T′_{AIR} is 23° C.) may be different from the target temperature corresponding to the surface temperature (e.g., T′_{Surface} is 29° C.).

Next, in step S315, an air heating operation is performed by the air conditioner according to the air heating duration, and a surface heating operation is performed by each of the plurality of heater devices according to the corresponding surface heating duration. After calculating the air heating duration and the plurality of surface heating durations corresponding to the plurality of interior surfaces, the processor 110 may instruct the air conditioner 170 to start performing the air heating operation by a preset heating power (e.g., Q_{HP}), and a length of time during which the air heating operation is continuously performed is equal to the air heating duration; after calculating the air heating duration and the plurality of surface heating durations corresponding to the plurality of interior surfaces, the processor 110 may instruct each of the surface heater device groups 180(1) to 180(P) to start performing the surface heating operation by a preset heating power (e.g., Q_{SH}), and a length of time during which each of the surface heating operations is continuously performed is equal to the surface heating duration.

Next, in step S316, the processor determines whether the air temperature and the surface temperatures is less than a target temperature.

In response to the air temperature and the surface temperatures being less than the target temperature, step S317 is performed; in response to the air temperature and the surface temperatures not being less than the target temperature, step S318 is performed.

In step S317, the air heating operation is continuously performed by the air conditioner 170, and the surface heating operations are continuously performed by the plurality of heater device groups 180(1) to 180(P). In other words, if the processor 110 finds that the air temperature has not risen to the target temperature, the processor 110 instructs the air conditioner 170 to continue performing the air heating operation until the air temperature rises to the target temperature (i.e., continuing to step S318); if the processor 110 finds that the surface temperature of one interior surface has not risen to the target temperature, the processor 110 instructs the corresponding surface heating array to continue performing the surface heating operation on the interior surface until the corresponding surface temperature rises to the target temperature (i.e., continuing to step S318). In the first stage, in the surface heating operation, the plurality of heaters of each of the plurality of heater devices 181(1) to 181(P) are all enabled and at a first heating power.

In step S318, the processor 110 instructs the air conditioner 170 to stop performing the air heating operation. In other words, if the processor 110 finds that the air temperature has risen to the target temperature, only the air heating operation performed by the air conditioner will be stopped. In an embodiment, if the processor 110 finds that the surface temperature of one interior surface has risen to the target temperature, the processor 110 will not stop the surface heating operation performed by the corresponding surface heating array. Instead, the processor 110 may instruct the corresponding surface heating array to perform the surface heating operation by using the same heating power (e.g., the first power) or a lower heating power (e.g., the second heating power), so as to reduce the power consumption for heating up the vehicle 10.

The above steps S314 to S318 may be regarded as the first stage (the preheating stage) of the temperature control procedure performed by the processor 110. In this first stage, the air and the interior surfaces in the vehicle 10 may be preheated to the target temperature. After step S318 is completed, the processor 110 may continue to perform the second stage (the power saving stage) of the temperature control procedure (see FIG. 3C or FIG. 3D).

In another embodiment, the temperature control system 11 may calculate a heating start time by using the received vehicle use time (or the vehicle use schedule) to perform the air heating operation and the surface heating operation more accurately and effectively. The following paragraph is described with reference to FIG. 3B.

FIG. 3B is a flowchart of a temperature control method illustrated according to another embodiment of the disclosure. Referring to FIG. 3B, steps S322, S323, S324, and S325 are the same as steps S311, S312, S313, and S314 in FIG. 3A, and details thereof will not be repeated.

First, in step S321, the processor 110 receive a vehicle use time (e.g., 2019/10/25 17:45; or known as a space use time) from the communication circuit unit 120 of the vehicle 10 (or the space 10). In an embodiment, the vehicle use time may be input through the input/output device 140. This disclosure is not limited to the format of the vehicle use time.

In response to the air temperature and the surface temperatures being less than a target temperature, an air heating duration of the air conditioner and a surface heating duration of each of the plurality of heater devices are calculated according to the target temperature, the air temperature and the plurality of surface temperatures (step S325), and step S326 is then performed.

In step S326, the processor 110 calculates an air heating start time corresponding to the air conditioner according to the air heating duration and the vehicle use time, and calculates a plurality of surface heating start times corresponding to the plurality of heater devices according to the plurality of surface heating durations and the vehicle use time.

The processor 110 may calculate a start time for performing the air heating operation (an air heating start time) according to the air heating duration and the vehicle use time.

For example, it is assumed that the vehicle use time is “2019/10/25 17:45” and the air heating duration is 900 seconds (15 minutes). Accordingly, the processor 110 may subtract the air heating duration from the vehicle use time to obtain the air heating start time of “2019/10/25 17:30”.

Similarly, the processor 110 may calculate a start time for performing the surface heating operation on one interior surface (surface heating start time) according to the surface heating duration corresponding to the interior surface and the vehicle use time.

For example, it is assumed that the vehicle use time is “2019/10/25 17:45” and the corresponding surface heating duration is 600 seconds (10 minutes). Accordingly, the processor 110 may subtract the surface heating duration from the vehicle use time to obtain the surface heating start time of “2019/10/25 17:35”.

After the air heating duration and the surface heating duration are obtained, in step S327, the air conditioner is instructed to perform the air heating operation at the air heating start time, and each of the plurality of heater devices is instructed to perform a surface heating operation at the plurality of surface heating start times such that the air temperature and the plurality of surface temperatures are able to reach the target temperature at the vehicle use time.

The above steps S325 to S327 may be regarded as the first stage (the preheating stage) of the temperature control procedure performed by the processor 110 in this embodiment. In this first stage, before the vehicle use time, through the air heating operation performed at the air heating start time and surface heating operation performed at the surface heating start time, the air and the interior surfaces of the vehicle 10 may be preheated to the target temperature at the vehicle use time. After step S327 is completed, the processor 110 may continue to perform the second stage (the power saving stage) of the temperature control procedure (see FIG. 3C or FIG. 3D).

In this embodiment, step S327 may not be continued to the second stage, but may be continued to steps S316 to S318 (shown as dashed lines). For steps S316 to S318, please refer to FIG. 3A.

In embodiments where the space 10 is not the vehicle (e.g., the conference room), the user of the conference room 10 may operate an electronic device (e.g., a cell phone or a computer) of the user to inform the processor 110 of the conference room of the space use time (the time the meeting started) or the space use schedule (e.g., the time slot used for each day of the conference room) through a network connection. The processor 110 may perform the preheating stage according to the space use time/the space use schedule.

FIG. 3C is a flowchart of a second stage and a third stage in a temperature control procedure in a temperature control method illustrated according to an embodiment of the disclosure. Referring to FIG. 3C, after the first stage is completed, the processor 110 performs a second stage of the temperature control procedure, that is, steps S330 to S340.

In step S330, the processor 110 periodically senses, by each of a plurality of pressure sensing devices disposed in the plurality of interior surfaces of the vehicle, a pressure value to which each of the plurality of interior surfaces is subjected. Next, in step S340, the processor 110 manages the plurality of surface heating operations performed by the plurality of heater devices 181(1) to 181(P) according to the plurality of pressure values corresponding to the plurality of interior surfaces.

Step S340 includes steps S341 to S343. In step S341, the processor 110 determines whether each of the plurality of pressure values is less than a pressure value. In response to determining that one or more first pressure values among the plurality of pressure values are less than a pressure threshold, step S342 is performed; in response to determining that one or more second pressure values among the plurality of pressure values are not less than a pressure threshold, step S343 is performed.

In step S342, the processor 110 identifies one or more first interior surfaces corresponding to the one or more first pressure values among the plurality of interior surfaces, and instructs one or more first heater devices disposed on the one or more first interior surfaces among the plurality of heater devices to stop performing the surface heating operation. For instance, in response to identifying that one or more first interior surfaces corresponding to the one or more first pressure values among the plurality of interior surfaces are less than the pressure threshold, the processor 110 may consider that the one or more first interior surface are not touched by the passenger. Then, the processor 110 may stop the surface heating operation performed by each of one or more first heater devices in the one or more first interior surfaces.

In step S343, the processor 110 identifies one or more second interior surfaces corresponding to the one or more second pressure values among the plurality of interior surfaces, instructs one or more second heater devices disposed on the one or more second interior surfaces to keep on performing the surface heating operation or perform a local heating operation on the one or more second heater device. For instance, in response to identifying that one or more second interior surfaces corresponding to the one or more second pressure values among the plurality of interior surfaces are not less than the pressure threshold, the processor 110 may consider that the one or more second interior surface are touched by the passenger. Then, the processor 110 may maintain the surface heating operation performed by each of one or more second heater devices in the one or more second interior surfaces, or the processor 110 may further perform the local heating operation on the one or more second heater devices.

Next, in step S350, whether the air temperature drops to a reheating temperature threshold is determined. In response to determining that the air temperature drops to the reheating temperature threshold, step S360 is performed; in response to determining that the air temperature does not drop to the reheating temperature threshold, step S330 is performed.

In the second stage, since the air heating operation performed by the air conditioner has been stopped, the air temperature of in the vehicle 10 may gradually drop down from the target temperature. Therefore, in response to determining that the air temperature drops to the reheating temperature threshold, the processor 110 performs a third stage (a.k.a. a reheating stage) of the temperature control procedure (step S360), so as to reheat the air in the vehicle 10.

In step S360, the processor 110 instructs the air conditioner 170 to perform the air heating operation, and instructs each of the plurality of heater devices 181(1) to 181(P) to perform the surface heating operation until the air temperature currently sensed rises to the target temperature. In the third stage, in the surface heating operation, the plurality of heaters of each of the plurality of heater devices 181(1) to 181(P) are all enabled and at the first heating power.

After the air temperature current sensed rises to the target temperature, step S330 is performed, that is, the processor 110 performs the second stage of the temperature control procedure again.

However, in another embodiment, in the second stage, the processor 110 may manage the plurality of surface heating operations performed by the plurality of heater devices without the pressure sensing device.

FIG. 3D is a flowchart of a second stage and a third stage in a temperature control procedure in a temperature control method illustrated according to another embodiment of the disclosure. Referring to FIG. 3D, in this embodiment, after the first stage is completed, the processor 110 performs the second stage of the temperature control procedure, that is, steps S370 to S380.

In step S370, the processor 110 periodically identifies a plurality of surface sub-temperatures of each of the plurality of interior surfaces sensed by the plurality of temperature sensors of each of the plurality of second temperature sensing devices. Next, in step S380, the processor 110 manages the plurality of surface heating operations performed by the plurality of heater devices according to the plurality of surface sub-temperatures of the plurality of interior surfaces.

Step S380 includes steps S381 to S383. In step S381, the processor 110 determines whether a plurality of surface sub-temperatures of each of the plurality of interior surfaces conform with a first pattern. In response to determining that a plurality of first surface sub-temperatures of each of one or more first interior surfaces among the plurality of interior surfaces do not conform with the first pattern, step S382 is performed; in response to determining that a plurality of second surface sub-temperatures of each of one or more second interior surfaces among the plurality of interior surfaces conform with the first pattern, step S383 is performed. In other words, the processor 110 analyzes the plurality of surface sub-temperatures of each of the plurality of interior surfaces, finds out the interior surfaces having the surface sub-temperatures that conform with the first pattern, and indentifies the found interior surfaces as the second interior surfaces (the rest of the interior surfaces having the surface sub-temperatures that do not conform with the first pattern are identified as the first interior surfaces).

In this embodiment, the first pattern includes at least one of following conditions: (1) an average value of the plurality of first surface sub-temperatures is greater than a trigger temperature threshold; (2) a temperature distribution map corresponding to the plurality of surface sub-temperature matches a temperature distribution map sample obtained through a machine learning (e.g., a temperature distribution map obtained after the passenger has sit on the interior surfaces for a period of time); (3) a difference between the average value of the plurality of surface sub-temperatures and the air temperature is greater than a first trigger temperature difference threshold; and (4) a difference between a largest one and a smallest one of the plurality of surface sub-temperatures is greater than a second trigger temperature difference threshold.

For example, it is assumed that the first pattern is set as “the average value of the plurality of first surface sub-temperatures is greater than the trigger temperature threshold”. The processor 110 calculates the average value of the surface sub-temperatures sensed on each of the interior surfaces (e.g., each interior surface corresponds to one average value). When the processor 110 determines that calculated average value is not greater than the trigger temperature threshold, the processor identifies the interior surface corresponding to the average value as the second interior surface; when the processor 110 determines that calculated average value is greater than the trigger temperature threshold, the processor 110 identifies the interior surface corresponding to the average value as the first interior surface.

In this embodiment, the processor 110 determines that it is not required to continue performing the surface heating operation on the first interior surfaces that do not conform with the first pattern. That is to say, the processor 110 may consider that the average value of the surface sub-temperatures of the interior surface cannot rise to become a value greater than trigger temperature threshold since no passenger is sitting on the surfaces. In contrast, the processor 110 determines that it is required to continue performing the surface heating operation or performing the local heating operation on the second interior surfaces that conform with the first pattern. That is to say, the processor 110 may consider that the average value of the surface sub-temperatures of the interior surface can rise to become a value greater than trigger temperature threshold due to the body temperature of the passenger since the passenger is sitting on the surfaces. The trigger temperature threshold may be preset to a value less than or equal to the normal body temperature (e.g., 37.5° C.).

In step S382, the processor 110 instructs one or more first heater devices disposed on the one or more first interior surfaces to stop performing the surface heating operation.

In step S383, the processor 110 instructs one or more second heater devices disposed on the one or more second interior surfaces to keep on performing the surface heating operation or perform a local heating operation on the one or more second heater device. For instance, the processor 110 may consider that the one or more second interior surfaces are touched by the passenger. Then, the processor 110 may maintain the surface heating operation performed by each of one or more second heater devices in the one or more second interior surfaces, or the processor 110 may further perform the local heating operation on the one or more second heater devices.

Next, in step S350, whether the air temperature drops to a reheating temperature threshold is determined. In response to determining that the air temperature drops to the reheating temperature threshold, step S360 is performed; in response to determining that the air temperature does not drop to the reheating temperature threshold, step S370 is performed. The details of steps S350 and S360 have been described above, and are not repeated here.

In an embodiment, the processor 110 further reduces the maintained heating power of the surface heating operation performed by each of the one or more second heater devices maintained. That is, the processor 110 adjusts the heating power of each of the one or more second heater devices from the first heating power to a second heating power to further save power. Among them, the first heating power is greater than the second heating power.

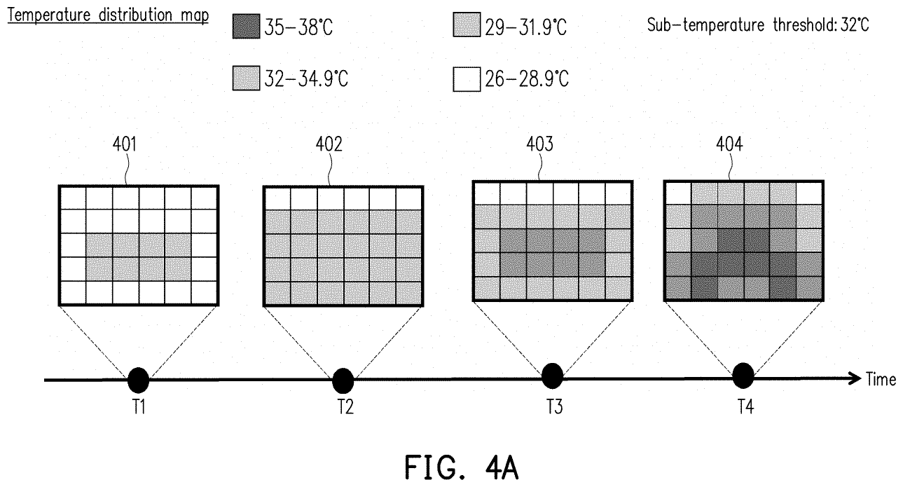

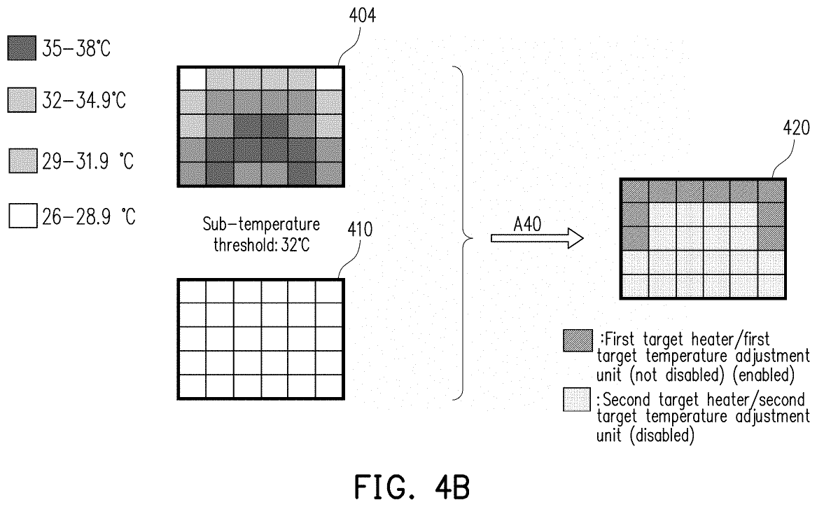

The details of the local heating operation will be described below using FIGS. 4A to 4B.

FIG. 4A is a schematic diagram of a temperature distribution map of second temperature sensing devices on interior surfaces at different time points illustrated according to an embodiment of the disclosure. Referring to FIG. 4A, there are different temperature distribution maps 401, 402, 403, and 404 of one interior surface at different time points T1, T2, T3, and T4 shown in FIG. 4A. According to the surface sub-temperatures sensed by the temperature sensors of the second temperature sensing device of one interior surface at one specific time point, the processor 110 may identify the temperature distribution map at the specific time point. The processor 110 may record the temperature distribution maps at different time points for each interior surface. In addition, the processor 110 may use the recorded temperature distribution maps to obtain a corresponding temperature distribution map sample through the machine learning, so as to further determine whether there is a passenger currently touching the corresponding interior surface by using the temperature distribution map sample currently obtained.

As shown in FIG. 4A, as the time increases, a value of the surface sub-temperature on the interior surface becomes higher. Based on this phenomenon, the processor 110 may determine that the interior surface is being heated up by the body temperature of the passenger.

In this embodiment, the processor 110 may perform the local heating operation on the second interior surface by using a sub-temperature threshold. The processor 110 identifies a plurality of target surface sub-temperatures sensed by a plurality of target temperature sensors of a target second temperature sensing device disposed on the second interior surface. Here, the processor 110 may further identify a plurality of first target heaters and a plurality of second target heaters among all target heaters of the second interior surface through a comparison result of the sub-temperature threshold and the plurality of target surface sub-temperatures, enable the plurality of first target heaters and disable the plurality of second plurality of first target heaters.

In other words, the processor 110 may instruct, according to the plurality of target surface sub-temperatures, the second heater device on the second interior surface to enable a plurality of first target heaters in a first part of a plurality of target heaters of the second heater device, and disable a plurality of second target heaters in a second part of the plurality of target heaters.

In response to determining that a plurality of first target surface sub-temperatures among the plurality of target surface sub-temperatures are less than the sub-temperature threshold, the processor 110 identifies the plurality of first target heaters corresponding to the plurality of first target surface sub-temperatures from the plurality of target heaters; in response to determining that a plurality of second target surface sub-temperatures among the plurality of target surface sub-temperatures are not less than the sub-temperature threshold, the processor 110 identifies the plurality of second target heaters corresponding to the plurality of second target surface sub-temperatures from the plurality of target heaters.

In an embodiment, the processor 110 further reduces the heating power of the plurality of first target heater enabled. That is, the processor 110 adjust the heating power of the plurality of first target heaters from the first heating power to the second heating power to further save power. Among them, the first heating power is greater than the second heating power.

FIG. 4B is a schematic diagram of a plurality of first target heaters/first target temperature adjustment units and a plurality of second target heaters/second target temperature adjustment units determined based on a temperature distribution map of second temperature sensing devices illustrated according to an embodiment of the disclosure. Referring to FIG. 4B, it is assumed that at the time point T4, the processor 110 identifies the plurality of surface sub-temperature on the temperature distribution map 404, and the sub-temperature threshold is preset as 32 degrees Celsius. In this example, as shown by an arrow A40, the processor 110 may identify a plurality of first target heaters (respectively corresponding to a plurality of first surface sub-temperature less than the sub-temperature threshold) and a plurality of second target heaters (respectively corresponding to a plurality of second surface sub-temperature not less than the sub-temperature threshold) among all the target heaters corresponding to a heater device 410.

Next, the processor 110 enables the plurality of first target heaters of the heater device 410, and disables the plurality of second target heaters, so as to adjust the heater device 410 into a heater device 420.

In the above example, 20 of the 30 heaters of the heater device 410 are disabled (i.e., to stop performing the surface heating operation originally performed). In this way, through the local heating operation, the energy consumption of the heater device 410 is reduced by approximately 66.7% (20/30) so that the power saving effect is achieved.

In this example, the processor 110 considers that the areas corresponding to the plurality of second heaters in the interior surface have been heated by the body temperature such that it is not required to continue providing power to the plurality of second target heaters to enable the plurality of second target heaters. In other words, by performing the local heating operation on the heater devices, the power may be effectively saved.

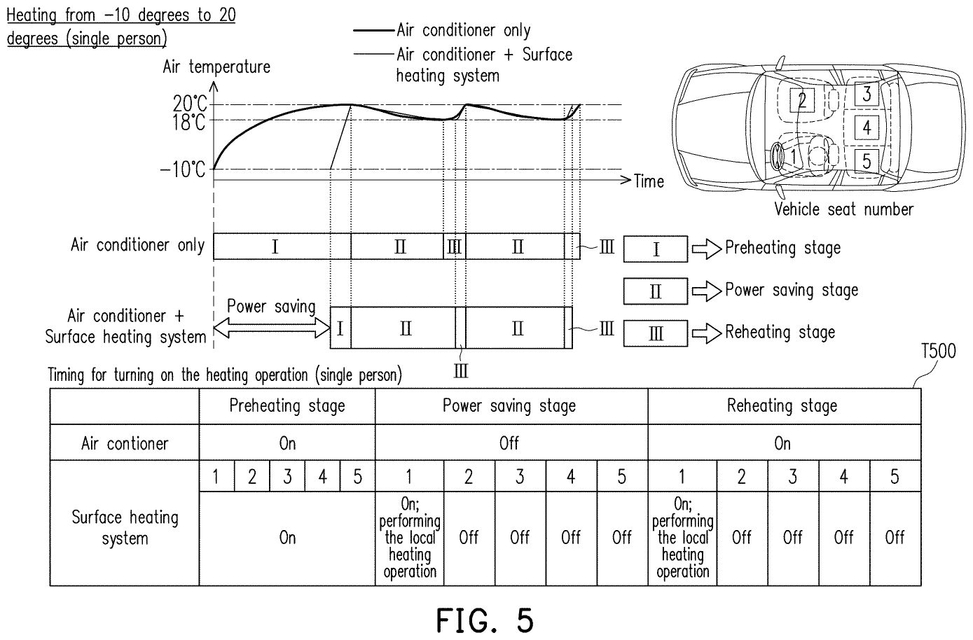

FIG. 5 is a schematic diagram of multiple stages in a temperature control system illustrated according to an exemplary embodiment of the disclosure. Referring to FIG. 5, it is assumed that only one driver is located at an interior surface 1 of the vehicle.

In this example, compared with the conventional technology, in the preheating stage, since the time points for starting the air conditioner and the surface heating system can be accurately calculated, the temperature control system provided in this embodiment can reduce the power consumption in the preheating stage.

Further, as shown by a table T500, in the preheating stage, the air conditioner 170 and heater devices located at the interior surfaces 1 to 5 in the surface heating system are all turned on (i.e., to perform the heating operations). Next, in the power saving stage, the temperature control system 11 may identify that the interior surfaces 2 to 5 are not touched by any passenger, and thus turn off the heater devices of the interior surfaces 2 to 5. Next, in the reheating stage, the temperature control system 11 may turn on the air conditioner 170 again so that the air temperature in the vehicle rises.

In the above embodiments, densities of the plurality of temperature adjustment units provided on one interior surface are equal, but the disclosure is not limited thereto. For instance, in other embodiment, densities of the plurality of temperature adjustment units provided on different interior surfaces are different, it can be adjusted according to heating requirements.

Each of the plurality of interior surfaces has a plurality of areas, wherein each of the plurality of areas has a different array unit density. In addition, a plurality of temperature sensors of one second temperature sensing device provided on one interior surface and a plurality of heaters of one corresponding heater device constitute a plurality of array units. The plurality of array units are disposed according to the array unit density of each of the plurality of areas of said one interior surface.

Values of the array unit densities corresponding to the different areas of each interior surface may be set according to the heating requirements of the different areas of each interior surface.

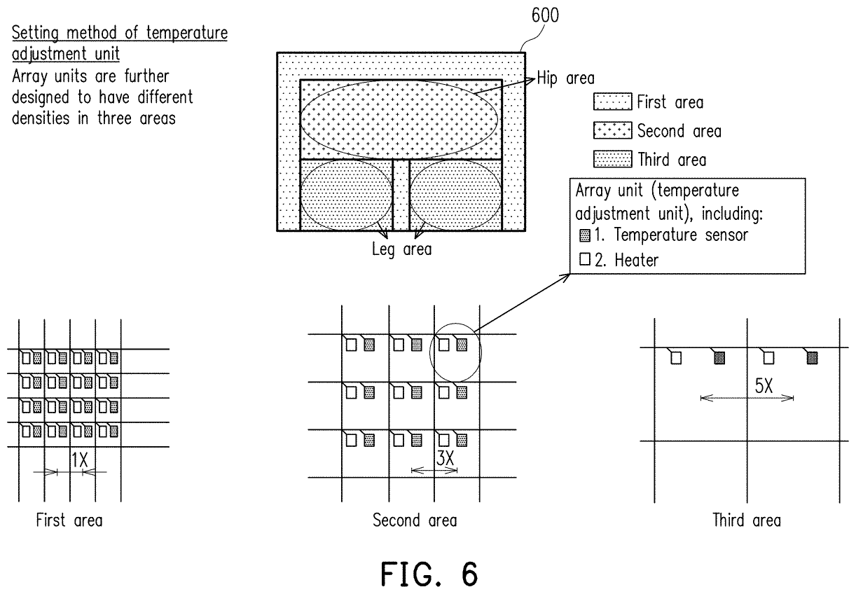

FIG. 6 is a schematic diagram of temperature adjustment units disposed in different areas illustrated according to an embodiment of the disclosure. Referring to FIG. 6, it is assumed that an interior surface 600 is a surface of a seat cushion of a seat. The interior surface 600 may be divided into a first area, a second area and a third area. The third area has the lowest heating requirements (because the leg portion of the human body has a fastest rate for heating up the interior 600) and has a smallest array unit density (e.g., an array unit distance between the temperature adjustment units is “5X”); the first area has the highest heating requirements (the area touched by the passenger is of the smallest) and has a largest array unit density (e.g., an array unit distance between the temperature adjustment units is “1X”). X is, for example, a preset array unit distance.

In summary, the temperature control system and the temperature control method provided by the embodiments of the disclosure can be used to calculate the heating durations of the air conditioner and the surface heating system of the space. In addition, according to the received space use time, the temperature control system and the temperature control method provided in the embodiments of the disclosure may further turn on the air conditioner and the surface heating system at the calculated air heating start time and the surface heating start time before the space use time, so as to perform a preheating for the space. In this way, the energy consumption of the temperature control system (heating system) of the space may be reduced, and a working efficiency of the temperature control system of the space may also be improved. On the other hand, the temperature control system and the temperature control method provided in the embodiments of the disclosure can further determine the interior surfaces that one or more users are in contact with, so as to stop operations of the heaters from other interior surface and manage operations of a plurality of heaters on the interior surface (the local heating operation). As a result, in addition to power saving, the one or more users will have a better comfort experience for the space in which they are located.

It will be apparent to those skilled in the art that various modifications and variations can be made to the disclosed embodiments. It is intended that the specification and examples be considered as exemplary only, with a true scope of the disclosure being indicated by the following claims and their equivalents.

1. A temperature control system adapted to a space, comprising:
an air conditioner;
a surface heating system, comprising a plurality of heater devices arranged in an array and respectively disposed on a plurality of interior surfaces of the space, the plurality of heater devices being configured to heat up the plurality of interior surfaces;
a temperature detection system, comprising a first temperature sensing device and a plurality of second temperature sensing devices arranged in an array, wherein the first temperature sensing device is configured to periodically sense an air temperature of the space, wherein the plurality of second temperature sensing devices are respectively disposed on the plurality of interior surfaces of the space, and configured to periodically sense a surface temperature of each of the plurality of interior surfaces; and
a processor, wherein in response to the air temperature and the surface temperatures being less than a target temperature,
the processor is configured to perform a first stage of a temperature control procedure,
wherein in the first stage,
the processor is further configured to calculate an air heating duration of the air conditioner and a surface heating duration of each of the plurality of heater devices according to the target temperature, the air temperature and the plurality of surface temperatures,
wherein the processor is further configured to instruct the air conditioner to perform an air heating operation according to the air heating duration, and instruct each of the plurality of heater devices to perform a surface heating operation according to the corresponding surface heating duration,
wherein in response to the air temperature currently sensed and the plurality of surface temperatures currently sensed reaching the target temperature, the processor is further configured to instruct the air conditioner to stop performing the air heating operation so as to finish performing the first stage.

2. The temperature control system according to claim 1, wherein each of the plurality of heater devices has a plurality of heaters arranged in an array, and each of the plurality of second temperature sensing devices has a plurality of temperature sensors arranged in an array, wherein the plurality of second temperature sensing devices respectively correspond to the plurality of heater devices, and the plurality of temperature sensors of each of the plurality of second temperature sensing devices correspond to the plurality of heaters of the corresponding heater device.

3. The temperature control system according to claim 2, further comprising: a plurality of pressure sensing devices, respectively disposed in the plurality of interior surfaces, wherein after the first stage is completed, the processor performs a second stage of the temperature control procedure,
wherein in the second stage, each of the plurality of pressure sensing devices periodically senses a pressure value to which each of the plurality of interior surfaces is subjected, and
the processor manages the plurality of surface heating operations performed by the plurality of heater devices according to the plurality of pressure values corresponding to the plurality of interior surfaces.

4. The temperature control system according to claim 3, wherein in the step of managing the plurality of surface heating operations performed by the plurality of heater devices according to the plurality of pressure values sensed,
in response to determining that one or more first pressure values among the plurality of pressure values are less than a pressure threshold, the processor identifies one or more first interior surfaces corresponding to the one or more first pressure values among the plurality of interior surfaces, and instructs one or more first heater devices disposed on the one or more first interior surfaces among the plurality of heater devices to stop performing the surface heating operation,
in response to determining that one or more second pressure value among the plurality of pressure values are not less than the pressure threshold, the processor identifies one or more second interior surfaces corresponding to the one or more second pressure values among the plurality of interior surfaces, and instructs one or more second heater devices disposed on the one or more second interior surfaces among the plurality of heater devices to keep on performing the surface heating operation or perform a local heating operation on the one or more second heater device.

5. The temperature control system according to claim 4, wherein in the local heating operation,
the processor identifies a plurality of target surface sub-temperatures sensed by a plurality of target temperature sensors of a target second temperature sensing device disposed on the second interior surface,
wherein the processor instructs, according to the plurality of target surface sub-temperatures, the second heater device to enable a plurality of first target heaters in a first part of a plurality of target heaters of the second heater device and disable a plurality of second target heaters in a second part of the plurality of target heaters, wherein a plurality of first target surface sub-temperatures corresponding to the plurality of first target heaters among the plurality of target surface sub-temperatures are less than a sub-temperature threshold, and a plurality of second target surface sub-temperatures corresponding to the plurality of second target heaters among the plurality of target surface sub-temperatures are not less than the sub-temperature threshold.

6. The temperature control system according to claim 3,
wherein in response to determining that the air temperature drops to a reheating temperature threshold, the processor performs a third stage of the temperature control procedure,
wherein in the third stage, the processor instructs the air conditioner to perform the air heating operation, and instructs each of the plurality of heater devices to perform the surface heating operation until the air temperature currently sensed rises to the target temperature, wherein in the surface heating operation, the plurality of heaters of each of the plurality of heater devices are all enabled and at a first heating power,
wherein in response to the air temperature in the third stage rising to the target temperature, the processor performs the second stage of the temperature control procedure again.

7. The temperature control system according to claim 2,
wherein after the first stage is completed, the processor performs a second stage of the temperature control procedure,
wherein in the second stage,
the processor periodically identifies a plurality of surface sub-temperatures of each of the plurality of interior surfaces sensed by the plurality of temperature sensors of each of the plurality of second temperature sensing devices,
wherein the processor manages the plurality of surface heating operations performed by the plurality of heater devices according to the plurality of surface sub-temperatures of the plurality of interior surfaces.

8. The temperature control system according to claim 7, wherein in the step of managing the plurality of surface heating operations performed by the plurality of heater devices according to the plurality of surface sub-temperatures of the plurality of interior surfaces,
in response to determining that a plurality of first surface sub-temperatures of each of one or more first interior surfaces among the plurality of interior surfaces do not conform with a first pattern, the processor instructs one or more first heater devices disposed on the one or more first interior surfaces among the plurality of heater devices to stop performing the surface heating operation,
wherein in response to determining that a plurality of second surface sub-temperatures of each of one or more second interior surfaces among the plurality of interior surfaces conform with the first pattern, the processor instructs one or more second heater devices disposed on the one or more second interior surfaces among the plurality of heater devices to keep on performing the surface heating operation or perform a local heating operation on the one or more second heater device.

9. The temperature control system according to claim 8, wherein the first pattern comprises at least one of following conditions:
an average value of the plurality of first surface sub-temperatures is greater than a trigger temperature threshold;
a temperature distribution map corresponding to the plurality of first surface sub-temperature matches a temperature distribution map sample obtained through a machine learning;
a difference between the average value of the plurality of first surface sub-temperatures and the air temperature is greater than a first trigger temperature difference threshold; and
a difference between a largest one and a smallest one of the plurality of first surface sub-temperatures is greater than a second trigger temperature difference threshold.

10. A temperature control method, adapted to a temperature control system disposed in a space, wherein the temperature control system comprises an air conditioner, a surface heating system, a temperature detection system and a processor, wherein the surface heating system comprises a plurality of heater devices arranged in an array and respectively disposed on a plurality of interior surfaces of the space, and the method comprises:
periodically sensing an air temperature of the space by a first temperature sensing device of the temperature detection system, and periodically sensing a surface temperature of each of the plurality of interior surfaces by a plurality of second temperature sensing devices of the temperature detection system arranged in an array,
wherein the plurality of second temperature sensing devices are respectively disposed on the plurality of interior surfaces of the space;
in response to the air temperature and the surface temperatures being less than a target temperature, performing a first stage of a temperature control procedure,
wherein the first stage comprises:
calculating an air heating duration of the air conditioner and a surface heating duration of each of the plurality of heater devices according to the target temperature, the air temperature and the plurality of surface temperatures;
performing an air heating operation by the air conditioner according to the air heating duration, and performing a surface heating operation by each of the plurality of heater devices according to the corresponding surface heating duration; and
in response to the air temperature currently sensed and the plurality of surface temperatures currently sensed reaching the target temperature, instructing the air conditioner to stop performing the air heating operation so as to finish performing the first stage.

11. The temperature control method according to claim 10, wherein each of the plurality of heater devices has a plurality of heaters arranged in an array, and each of the plurality of second temperature sensing devices has a plurality of temperature sensors arranged in an array, wherein the plurality of second temperature sensing devices respectively correspond to the plurality of heater devices, and the plurality of temperature sensors of each of the plurality of second temperature sensing devices correspond to the plurality of heaters of the corresponding heater device.

12. The temperature control method according to claim 11, wherein the temperature control system further comprises a plurality of pressure sensing devices respectively disposed in the plurality of interior surfaces, and the method further comprises:
after the first stage is completed, performing a second stage of the temperature control procedure,
wherein the second stage comprises:
periodically sensing, by each of the plurality of pressure sensing devices, a pressure value to which each of the plurality of interior surfaces is subjected; and
managing the plurality of surface heating operations performed by the plurality of heater devices according to the plurality of pressure values corresponding to the plurality of interior surfaces.

13. The temperature control method according to claim 12, wherein the step of managing the plurality of surface heating operations performed by the plurality of heater devices according to the plurality of pressure values sensed comprises:
in response to determining that one or more first pressure values among the plurality of pressure values are less than a pressure threshold, identifying one or more first interior surfaces corresponding to the one or more first pressure values among the plurality of interior surfaces, and instructing one or more first heater devices disposed on the one or more first interior surfaces among the plurality of heater devices to stop performing the surface heating operation; and
in response to determining that one or more second pressure value among the plurality of pressure values are not less than the pressure threshold, identifying one or more second interior surfaces corresponding to the one or more second pressure values among the plurality of interior surfaces, and instructing one or more second heater devices disposed on the one or more second interior surfaces among the plurality of heater devices to keep on performing the surface heating operation or perform a local heating operation on the one or more second heater device.

14. The temperature control method according to claim 13, wherein the local heating operation comprises:
indentifying a plurality of target surface sub-temperatures sensed by a plurality of target temperature sensors of a target second temperature sensing device disposed on the second interior surface; and
instructing, according to the plurality of target surface sub-temperatures, the second heater device to enable a plurality of first target heaters in a first part of a plurality of target heaters of the second heater device and disable a plurality of second target heaters in a second part of the plurality of target heaters, wherein a plurality of first target surface sub-temperatures corresponding to the plurality of first target heaters among the plurality of target surface sub-temperatures are less than a sub-temperature threshold, and a plurality of second target surface sub-temperatures corresponding to the plurality of second target heaters among the plurality of target surface sub-temperatures are not less than the sub-temperature threshold.

15. The temperature control method according to claim 12, further comprising:
in response to determining that the air temperature drops to a reheating temperature threshold, performing a third stage of the temperature control procedure,
wherein the third stage comprises:
instructing the air conditioner to perform the air heating operation, and instructing each of the plurality of heater devices to perform the surface heating operation until the air temperature currently sensed rises to the target temperature, wherein in the surface heating operation, the plurality of heaters of each of the plurality of heater devices are all enabled and at a first heating power; and
in response to that the air temperature in the third stage rising to the target temperature, performing the second stage of the temperature control procedure again.

16. The temperature control method according to claim 11, further comprising:
after the first stage is completed, performing a second stage of the temperature control procedure,
wherein the second stage comprises:
periodically identifying a plurality of surface sub-temperatures of each of the plurality of interior surfaces sensed by the plurality of temperature sensors of each of the plurality of second temperature sensing devices; and
managing the plurality of surface heating operations performed by the plurality of heater devices according to the plurality of surface sub-temperatures of the plurality of interior surfaces.

17. The temperature control method according to claim 16, wherein the step of managing the plurality of surface heating operations performed by the plurality of heater devices according to the plurality of surface sub-temperatures of the plurality of interior surfaces comprises:
in response to determining that a plurality of first surface sub-temperatures of each of one or more first interior surfaces among the plurality of interior surfaces do not conform with a first pattern, instructing one or more first heater devices disposed on the one or more first interior surfaces among the plurality of heater devices to stop performing the surface heating operation; and
in response to determining that a plurality of second surface sub-temperatures of each of one or more second interior surfaces among the plurality of interior surfaces conform with the first pattern, instructing one or more second heater devices disposed on the one or more second interior surfaces among the plurality of heater devices to keep on performing the surface heating operation or perform a local heating operation on the one or more second heater device.

18. The temperature control method according to claim 17, wherein the first pattern comprises at least one of following conditions:
an average value of the plurality of first surface sub-temperatures is greater than a trigger temperature threshold;
a temperature distribution map corresponding to the plurality of first surface sub-temperature matches a temperature distribution map sample obtained through a machine learning;
a difference between the average value of the plurality of first surface sub-temperatures and the air temperature is greater than a first trigger temperature difference threshold; and
a difference between a largest one and a smallest one of the plurality of first surface sub-temperatures is greater than a second trigger temperature difference threshold.

19. A temperature control system adapted to a space, comprising:
an air conditioner;
a surface heating system, comprising a plurality of heater devices respectively disposed on a plurality of interior surfaces of the space, wherein each of the plurality of heater devices has a plurality of heaters arranged in an array, and the plurality of heater devices are configured to heat up the plurality of interior surfaces;
a temperature detection system, comprising a first temperature sensing device and a plurality of second temperature sensing devices, wherein the first temperature sensing device is configured to periodically sense an air temperature of the space, wherein the plurality of second temperature sensing devices are respectively disposed on the plurality of interior surfaces of the space, and configured to periodically sense a surface temperature of each of the plurality of interior surfaces, wherein each of the plurality of second temperature sensing devices has a plurality of temperature sensors arranged in another array, wherein the plurality of second temperature sensing devices respectively correspond to the plurality of heater devices, and the plurality of temperature sensors of each of the plurality of second temperature sensing devices correspond to the plurality of heaters of the corresponding heater device; and
a processor, wherein the processor is configured to receive a space use time through a communication circuit unit of the space,
wherein in response to the air temperature and the surface temperatures being less than a target temperature, the processor is further configured to perform a first stage of a temperature control procedure according to the space use time,
wherein in the first stage,
the processor is further configured to calculate an air heating duration of the air conditioner and a surface heating duration of each of the plurality of heater devices according to the target temperature, the air temperature and the plurality of surface temperatures,
wherein the processor is further configured to calculate an air heating start time corresponding to the air conditioner according to the air heating duration and the space use time, and calculate a plurality of surface heating start times corresponding to the plurality of heater devices according to the plurality of surface heating durations and the space use time,
wherein before the space use time, the processor is further configured to instruct the air conditioner to perform an air heating operation at the air heating start time, and instruct each of the plurality of heater devices to perform a surface heating operation at the plurality of surface heating start times such that the air temperature and the plurality of surface temperatures are able to reach the target temperature at the space use time.

20. The temperature control system according to claim 19, wherein each of the
plurality of heaters comprises a film heater, a ceramic heater or a coil heater.
